(19) United States
(12) Patent Application Publication
(10) Pub. No.: US 2025/0219311 A1
(43) Pub. Date: Jul. 3, 2025

(54) TERMINAL CONNECTION STRUCTURE

(71) Applicant: TOYOTA JIDOSHA KABUSHIKI KAISHA, Toyota-shi Aichi-ken (JP)

(72) Inventors: Hiroshi KAWANISHI, Nisshin-shi Aichi-ken (JP); Shingo NAGAI, Toyota-shi Aichi-ken (JP); Kengo OHIRA, Toyota-shi Aichi-ken (JP); Kenta KODAMA, Toyota-shi Aichi-ken (JP); Koichi KUWAHARA, Nagoya-shi Aichi-ken (JP); Shogo KAJIMOTO, Toyota-shi Aichi-ken (JP); Yuichiro KANADA, Toyota-shi Aichi-ken (JP); Takuya ISOMURA, Aichi-gun Aichi-ken (JP); Masashi IZUMI, Toyota-shi Aichi-ken (JP)

(73) Assignee: TOYOTA JIDOSHA KABUSHIKI KAISHA, Toyota-shi Aichi-ken (JP)

(21) Appl. No.: 18/973,170

(22) Filed: Dec. 9, 2024

(30) Foreign Application Priority Data
Dec. 27, 2023 (JP) 2023-220949

(51) Int. Cl. H01R 13/187; H01R 13/24

(52) U.S. Cl. CPC H01R 13/187; H01R 13/2492; H01R 2201/10; H01R 2201/26

(57) ABSTRACT

A terminal connection structure includes: a column-shaped male terminal that extends in an axial direction; a female terminal that demarcates a hole into which the male terminal is inserted; and at least one contact member that is sandwiched between an outer side surface of the male terminal and an inner side surface of the female terminal and that electrically connects the male terminal and the female terminal. The contact member includes a first contact portion and a second contact portion that are elastically deformed in a radial direction perpendicular to the axial direction, and the first contact portion and the second contact portion are provided at different positions from each other in the axial direction.

### CROSS-REFERENCE TO RELATED APPLICATION

This application claims priority to Japanese Patent Application No. 2023-220949 filed on Dec. 27, 2023, incorporated herein by reference in its entirety.

### BACKGROUND

### 1. Technical Field

The technology disclosed in the present specification relates to a terminal connection structure.

### 2. Description of Related Art

In Japanese Unexamined Patent Application Publication No. 2019-8878, a terminal connection structure is described. The terminal connection structure includes a rod-shaped male terminal and a tube-shaped female terminal. Between the male terminal and the female terminal, a contact member that electrically connects the two terminals is provided. The contact member is disposed between an outer side surface of the male terminal and an inner side surface of the female terminal, and is configured to be capable of elastically deforming in the radial direction.

### SUMMARY

For example, the above terminal connection structure is used in a dynamic power circuit of an electrified vehicle, or the like. In this case, a relatively large electric current flows through the terminal connection structure. When a large electric current flows through the male terminal and the female terminal, the amount of heat generation becomes large in the contact member that connects the two terminals. For restraining the heat generation of the contact member, it is effective to increase the area of the contact of the contact member with the male terminal and the female terminal. However, in the case where the contact member is enlarged in the axial direction for increasing the contact area of the contact member, the range of the elastic deformation of the contact member also increases when the male terminal is inserted into the female terminal. As a result, an insertion load (that is, an insertion resistance) necessary for inserting the male terminal into the female terminal increases. The present disclosure provides a technology that makes it possible to increase the contact area of the contact member and to reduce the insertion load necessary for inserting the male terminal into the female terminal.

A terminal connection structure in the present disclosure includes: a column-shaped male terminal that extends in an axial direction; a female terminal that demarcates a hole into which the male terminal is inserted; and at least one contact member that is sandwiched between an outer side surface of the male terminal and an inner side surface of the female terminal and that electrically connects the male terminal and the female terminal. The contact member includes a first contact portion and a second contact portion that are elastically deformed in a radial direction perpendicular to the axial direction, and the first contact portion and the second contact portion are provided at different positions from each other in the axial direction.

With the above terminal connection structure, the increase in the insertion load can be restrained even when the contact member is enlarged in the axial direction and the contact area of the contact member is increased. That is, when the male terminal is inserted into the female terminal, the first contact portion (or the second contact portion), first, elastically deforms, and thereafter, the second contact portion (or the first contact portion) elastically deforms. Thereby, a range of the contact member where the elastic deformations concurrently occur is relatively small, so that the increase in the insertion load is restrained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an end view showing the configuration of a terminal connection structure in Embodiment 1;

FIG. 2 is a sectional view of the terminal connection structure along line II-II in FIG. 1;

FIG. 3 is a perspective view of a contact member having a shape in a natural state where the contact member has been taken out from between a male terminal and a female terminal;

FIG. 4 is a plan view of the contact member having the shape in the natural state;

FIG. 5 is an end view of the contact member having the shape in the natural state along line V-V in FIG. 4;

FIG. 6 is an end view of a contact member having the shape in the natural state in Embodiment 2;

FIG. 7 shows a modification of the contact member in Embodiment 2;

FIG. 8 is a plan view of a contact member having the shape in the natural state in Embodiment 3; and

FIG. 9 is an end view of the contact member having the shape in the natural state along line IX-IX in FIG. 8.

### DETAILED DESCRIPTION OF EMBODIMENTS

In a first aspect of the present technology, as described above, a terminal connection structure may include: a column-shaped male terminal that extends in an axial direction; a female terminal that demarcates a hole into which the male terminal is inserted; and at least one contact member that is sandwiched between an outer side surface of the male terminal and an inner side surface of the female terminal and that electrically connects the male terminal and the female terminal. The contact member may include a first contact portion and a second contact portion that are elastically deformed in a radial direction perpendicular to the axial direction, and the first contact portion and the second contact portion may be provided at different positions from each other in the axial direction.

In a second aspect of the present technology, in addition to the above first aspect, the contact member may include a plurality of elastic pieces, and each of the plurality of elastic pieces may extend in the axial direction and is arranged in a circumferential direction. At least one of the plurality of elastic pieces may be a first elastic piece that includes the first contact portion and the second contact portion. In this case, the plurality of elastic pieces may be provided over the whole length of the outer side surface in the circumferential direction, or may be provided only on a partial section of the outer side surface in the circumferential direction.

In a third aspect of the present technology, in addition to the above second aspect, each of the plurality of elastic pieces may be the first elastic piece that includes the first contact portion and the second contact portion. In this configuration, the first contact portion and the second contact portion can be disposed evenly in the circumferential direction. Accordingly, the contact of the contact member with the male terminal and the female terminal is stably maintained.

In a fourth aspect of the present technology, in addition to the above third aspect, the contact member may include an upper end portion and a lower end portion, the upper end portion extending in the circumferential direction, the lower end portion extending in the circumferential direction. In this case, the plurality of elastic pieces may extend between the upper end portion and the lower end portion. In this configuration, the stiffness of the whole of the contact member is increased without impairing the elastic property.

In a fifth aspect of the present technology, in addition to the above fourth aspect, the first contact portion may extend from the upper end portion to an intermediate portion of the first clastic piece. Moreover, the second contact portion may extend from the lower end portion to the intermediate portion of the first elastic piece. This configuration has an aspect in terms of the increase in the contact area of the contact member.

In a sixth aspect of the present technology, in addition to the above fifth aspect, the contact member may contact with the inner side surface of the female terminal, at the upper end portion, the lower end portion, and the intermediate portion, and the contact member may contact with the outer side surface of the male terminal, at the first contact portion and the second contact portion. Alternatively, the contact member may contact with the outer side surface of the male terminal, at the upper end portion, the lower end portion, and the intermediate portion, and the contact member may contact with the inner side surface of the female terminal, at the first contact portion and the second contact portion. In this configuration, the contact member is stably held between the male terminal and the female terminal.

In a seventh aspect of the present technology, in addition to the above fifth aspect or sixth aspect, an elastic deformation amount of the first contact portion in the radial direction may be equal to an elastic deformation amount of the second contact portion in the radial direction. That is, in the contact member having a shape in a natural state where the contact member has been taken out from between the male terminal and the female terminal, a protrusion amount of the first contact portion in the radial direction with respect to the upper end portion and the intermediate portion and a protrusion amount of the second contact portion in the radial direction with respect to the lower end portion and the intermediate portion are equal to each other. In this configuration, the contact of the contact member with the male terminal and the female terminal is stably maintained.

In an eighth aspect of the present technology, in addition to the above fifth aspect or sixth aspect, an elastic deformation amount of the first contact portion in the radial direction may be smaller than an clastic deformation amount of the second contact portion in the radial direction. That is, in the contact member having the shape in the natural state where the contact member has been taken out from between the male terminal and the female terminal, the protrusion amount of the first contact portion in the radial direction with respect to the upper end portion and the intermediate portion may be smaller than the protrusion amount of the second contact portion in the radial direction with respect to the lower end portion and the intermediate portion.

In a ninth aspect of the present technology, in addition to the above eighth aspect, the first contact portion may be provided at a position that is closer to an opening of the hole of the female terminal than the second contact portion is. In this configuration, the clastic deformation amount of the first contact portion positioned on the opening side of the hole of the female terminal can be relatively lessened, and the insertion load can be more effectively reduced.

In a tenth aspect of the present technology, in addition to any one of the above second to eighth aspects, at least one of the plurality of elastic pieces other than the first elastic piece may be a second clastic piece including a third contact portion that is elastically deformed in the radial direction. In this case, the third contact portion may be larger in the dimension in the axial direction than each of the first contact portion and the second contact portion. This configuration has an aspect in terms of the increase in the contact area of the contact member.

In an eleventh aspect of the present technology, in addition to the above tenth aspect, each of the plurality of elastic pieces may include both of the first contact portion and the second contact portion, or the third contact portion. In this case, the circumferential array order of an elastic piece (first elastic piece) including both of the first contact portion and the second contact portion and an elastic piece (second elastic piece) including the third contact portion is not particularly limited, and can be freely designed.

In a twelfth aspect of the present technology, in addition to the above eleventh aspect, the first elastic piece including both of the first contact portion and the second contact portion and the second elastic piece including the third contact portion may be alternately arranged along the circumferential direction. In this configuration, the first elastic piece and the second elastic piece can be disposed evenly in the circumferential direction. Accordingly, the contact of the contact member with the male terminal and the female terminal is stably maintained. As another aspect, two or more first elastic pieces adjacent to each other and two or more second elastic pieces adjacent to each other may be alternately arranged along the circumferential direction.

In a thirteenth aspect of the present technology, in addition to any one of the above tenth to twelfth aspects, the contact member may include an upper end portion and a lower end portion, the upper end portion extending in the circumferential direction, the lower end portion extending in the circumferential direction. In this case, the plurality of clastic pieces may extend between the upper end portion and the lower end portion. In this configuration, the stiffness of the whole of the contact member is increased without impairing the elastic property.

In a fourteenth aspect of the present technology, in addition to the above thirteenth aspect, the first contact portion may extend from the upper end portion to an intermediate portion of the first elastic piece. Moreover, the second contact portion may extend from the lower end portion to the intermediate portion of the first elastic piece. Moreover, the third contact portion may extend from the upper end portion to the lower end portion. This configuration has an aspect in terms of the increase in the contact area of the contact member.

In a fifteenth aspect of the present technology, in addition to the above fourteenth aspect, the contact member may contact with the inner side surface of the female terminal, at the upper end portion, the lower end portion, and the intermediate portion, and the contact member may contact with the outer side surface of the male terminal, at the first contact portion, the second contact portion, and the third contact portion. Alternatively, the contact member may contact with the outer side surface of the male terminal, at the upper end portion, the lower end portion, and the intermediate portion, and the contact member may contact with the inner side surface of the female terminal, at the first contact portion, the second contact portion, and the third contact portion. In this configuration, the contact member is stably held between the male terminal and the female terminal.

In a sixteenth aspect of the present technology, in addition to any one of the above first to fifteenth aspects, the terminal connection structure may be equipped in an electrified vehicle. In this case, one of the male terminal and the female terminal may be electrically connected to an electric motor that drives a wheel of the electrified vehicle. Moreover, the other of the male terminal and the female terminal may be electrically connected to an electric power control circuit that controls an electric current that flows through the electric motor.

Typical and non-limitative specific examples of the present disclosure will be described below in detail with respect to the drawings. This detailed description is simply intended to show details of the present disclosure to a person skilled in the art, and is not intended to limit the scope of the present disclosure. Further, additional characteristics and disclosures described below can be used separately from or together with other characteristics and disclosures, for providing further improved terminal connection structures.

Further, combinations of characteristics and processes disclosed in the following detailed description are not essential for carrying out the present disclosure, in the broadest sense, and are particularly described only for explaining typical specific examples of the present disclosure. Furthermore, various characteristics of the above and following typical specific examples and various characteristics described in the independent claim and the dependent claims do not need to be combined in accordance with the described specific examples or the listed order, when additional and useful embodiments of the present disclosure are provided.

All characteristics described in the present specification and/or the claims are intended to be disclosed individually and independently from each other, as limitations for disclosures at the time of the filing and specifying matters described in the claims, separately from configurations of characteristics described in embodiments and/or the claims. Furthermore, descriptions of all numerical ranges and all groups or aggregations are intended to disclose intermediate configurations, as limitations for disclosures at the time of the filing and specifying matters described in the claims.

### Embodiment 1

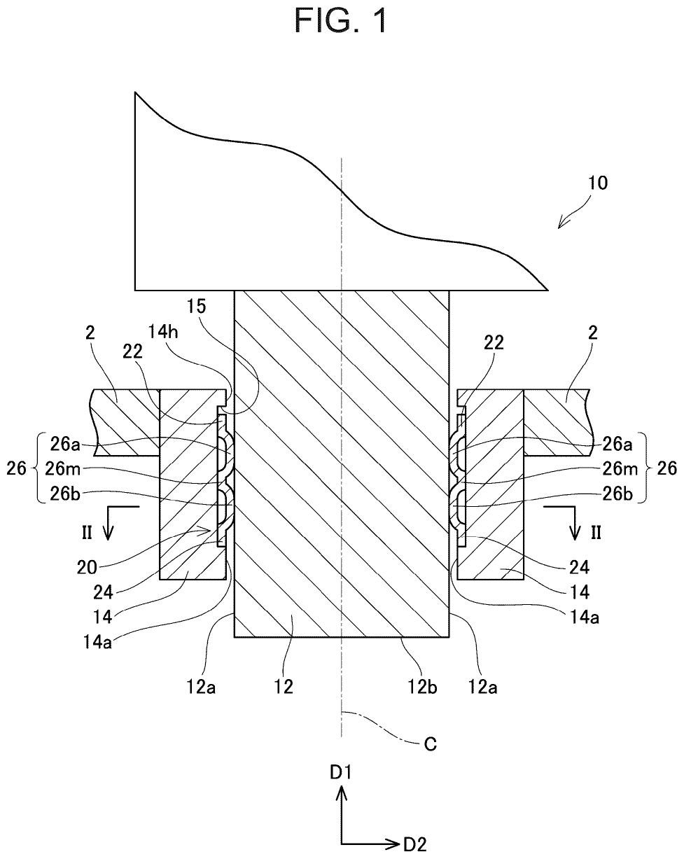

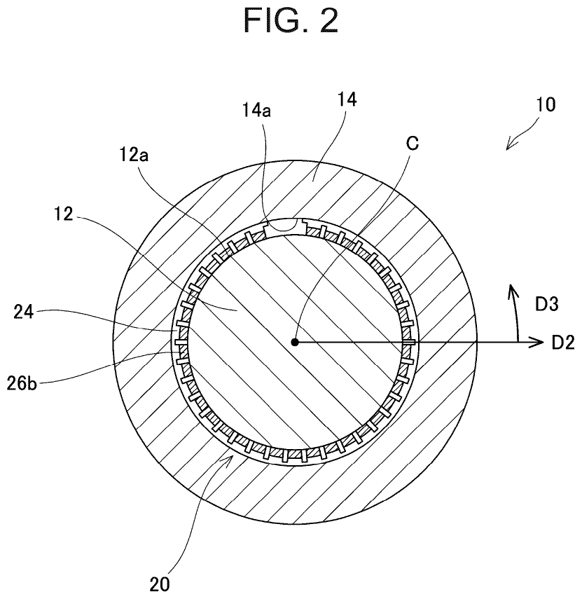

A terminal connection structure 10 in Embodiment 1 will be described with reference to FIG. 1 to FIG. 5. The terminal connection structure 10 can be used in a dynamic power circuit of an electrified vehicle. As shown in FIG. 1 and FIG. 2, the terminal connection structure 10 includes a male terminal 12, a female terminal 14, and a contact member 20. As an example, the female terminal 14 is electrically connected to an electric motor that drives a wheel of an electrified vehicle, through a bus-bar 2 of the electric motor. The male terminal 12 is electrically connected to an electric power control circuit that controls the electric current that flows through the electric motor. For example, the electric power control circuit includes an inverter circuit and a converter circuit.

As an example, the electric motor is a motor that is driven by three-phase alternating-current power, and the terminal connection structure 10 in the embodiment includes three male terminals 12 and three female terminals 14 for at least U-phase, V-phase, and W-phase. As an example, the three male terminals 12 are provided on a common terminal block, in an electric power control unit that includes the electric power control circuit. The three female terminal 14 are provided on a common terminal block, in a motor unit that includes the electric motor. The terminal connection structure 10 may further include a fourth male terminal 12 and a fourth female terminal 14 that connect a charging electric power source and a neutral point, for using the electric motor as a voltage-up or voltage-down circuit when the electrified vehicle is charged (that is, for performing a so- called neutral point charging). Some or all of configurations according to the present technology may be applied to all of the three pairs of terminals 12, 14 or the four pairs of terminals 12, 14, or may be applied to at least a pair of terminals 12, 14 of the three pairs of terminals 12, 14 or the four pairs of terminals 12, 14. The contact member 20 is a member that is interposed between the male terminal 12 and the female terminal 14 and that electrically connects the male terminal 12 and the female terminal 14.

The male terminal 12 is a member that has a roughly cylindrical shape. The male terminal 12 is composed of metal. The metal material composing the male terminal 12 is copper, for example. In a modification, the metal material composing the male terminal 12 may be aluminum. The male terminal 12 includes an outer side surface 12a and a distal end surface 12b that is positioned at a distal end of the male terminal 12.

The female terminal 14 is a member that includes a hole 14h, and the male terminal 12 is inserted from an opening of the hole 14h. The female terminal 14 receives the male terminal 12 in a detachable manner. The female terminal 14 is composed of metal. The metal material composing the female terminal 14 is copper, for example. In a modification, the material composing the female terminal 14 may be aluminum. The female terminal 14 includes an inner side surface 14a that faces the outer side surface 12a of the male terminal 12 and that demarcates the hole 14h.

In the present specification, a cylindrical coordinate system constituted by an axial direction D1, a radial direction D2, and a circumferential direction D3 is defined using the column-shaped male terminal 12 as a basis. The axial direction D1 is a direction parallel to the longitudinal direction of the column-shaped male terminal 12, and a coordinate axis for the axial direction D1 is defined as a central axis C of the male terminal 12. The axial direction D1 coincides with the direction of the insertion of the male terminal 12 into the female terminal 14. The radial direction D2 is a direction perpendicular to the axial direction D1, and is defined by a coordinate axis for which the central axis C of the male terminal 12 is adopted as the origin. Moreover, the circumferential direction D3 is a direction perpendicular to the axial direction D1 and the radial direction D2, and is defined by a coordinate axis that circles around the central axis C of the male terminal 12.

The contact member 20 is interposed between the male terminal 12 and the female terminal 14 in the radial direction D2. The contact member 20 is disposed between the outer side surface 12a of the male terminal 12 and the inner side surface 14a of the female terminal 14.

As shown in FIG. 3, the contact member 20 is a plate member that has a roughly cylindrical shape, and extends along the circumferential direction D3. The contact member 20 includes an upper end portion 22, a lower end portion 24, and a plurality of clastic pieces 26. Each of the plurality of elastic pieces 26 extends in the axial direction D1. The contact member 20 has a shape in which the plurality of elastic pieces 26 is arranged in the circumferential direction D3. The upper end portion 22 is positioned at an upper end of the contact member 20, and extends in the circumferential direction D3. The lower end portion 24 is positioned at a lower end of the contact member 20, and extends in the circumferential direction D3. Each of the plurality of elastic pieces 26 extends between the upper end portion 22 and the lower end portion 24. In this configuration, the stiffness of the whole of the contact member 20 is increased without impairing the clastic property.

That is, both ends of each elastic piece 26 are sequentially connected along

the circumferential direction D3, and thereby, the stiffness of the whole of the contact member 20 is increased. Meanwhile, the difference in the elastic modulus in the radial direction D2 among the plurality of elastic pieces 26 is relatively small regardless of whether both ends of each of the plurality of elastic pieces 26 are connected to another adjacent clastic piece 26 or are isolated from the other adjacent elastic piece 26.

The plurality of elastic pieces 26 is provided over almost the whole length of the outer side surface 12a of the male terminal 12. The “almost the whole length” in the present specification means about 70% or more of the whole length of the outer side surface 12a of the male terminal 12 in the circumferential direction D3. However, the plurality of elastic pieces 26 is not limited to this, and may be provided only on a partial section of the outer side surface 12a of the male terminal 12 in the circumferential direction D3.

Each of the plurality of elastic pieces 26 includes a first contact portion 26a, a second contact portion 26b, and an intermediate portion 26m that is positioned between the first contact portion 26a and the second contact portion 26b. The first contact portion 26a and the second contact portion 26b are elastically deformed along the radial direction D2. That is, the plurality of elastic pieces 26, at both ends, is joined to each other by the upper end portion 22 and the lower end portion 24. The first contact portion 26a extends from the upper end portion 22 to the intermediate portion 26m of the elastic piece 26. The second contact portion 26b extends from the lower end portion 24 to the intermediate portion 26m of the elastic piece 26. The first contact portion 26a and the second contact portion 26b are different from each other in the position in the axial direction D1.

As shown in FIG. 1 and FIG. 2, the contact member 20 contacts with the inner side surface 14a of the female terminal 14, at the upper end portion 22, the lower end portion 24, and the intermediate portion 26m. The contact member 20 contacts with the outer side surface 12a of the female terminal 12, at the first contact portion 26a and the second contact portion 26b. The contact member 20 has a shape in which the first contact portion 26a and the second contact portion 26b protrude to a radial inner side in the radial direction D2 so as to get close to the central axis C. That is, the male terminal 12 is press-fit into the female terminal 14, and the contact member 20 is electrically deformed in the radial direction D2 between the male terminal 12 and the female terminal 14. In this configuration, the contact member 20 is stably held between the male terminal 12 and the female terminal 14.

As another example, the intermediate portion 26m of the contact member 20 may contact with neither the outer side surface 12a of the male terminal 12 nor the inner side surface 14a of the female terminal 14. In this case, each of the first contact portion 26a and the second contact portion 26b functions as a plate spring in which only one end is supported. However, in some of the plurality of elastic pieces 26, there is a possibility that the intermediate portion 26m gets contact with or away from the outer side surface 12a of the male terminal 12 or the inner side surface 14a of the female terminal 14. In that case, there is a possibility that the elasticities of the first contact portion 26a and the second contact portion 26b in the radial direction D2 differs greatly between the contact state and the away state.

The orientation toward which the first contact portion 26a and the second contact portion 26b protrude in the radial direction D2 is not limited to the radial inner side, and may be a radial outer side. In this case, the contact member 20 may contact with the outer side surface 12a of the male terminal 12, at the upper end portion 22, the lower end portion 24, and the intermediate portion 26m, and may contact with the inner side surface 14a of the female terminal 14, at the first contact portion 26a and the second contact portion 26b. Although not particularly limited, the inner side surface 14a of the female terminal 14 has a concave portion 15. The lower end portion 24 of the contact member 20 is disposed in the concave portion 15 of the inner side surface 14a of the female terminal 14. The positioning of the contact member 20 in the axial direction D1 is performed by the concave portion 15. The dimension of the concave portion 15 in the axial direction D1 is larger than the dimension of the contact member 20 in the axial direction D1. This is because the dimension of the contact member 20 in the axial direction D1 changes when the first contact portion 26a and the second contact portion 26b elastically deforms in the radial direction D2.

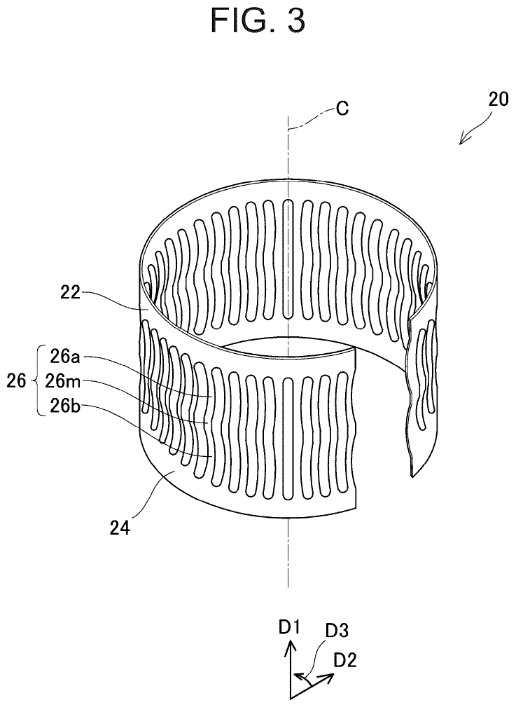

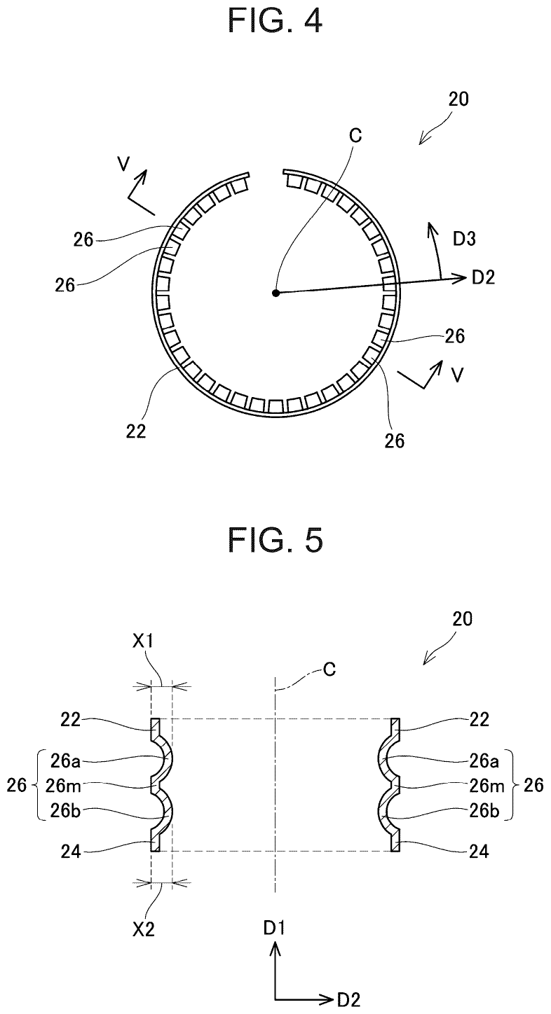

As shown in FIG. 4 and FIG. 5, the elastic deformation amount of the first contact portion 26a in the radial direction D2 and the elastic deformation amount of the second contact portion 26b in the radial direction D2 are equal to each other. That is, in the contact member 20 having a shape in a natural state where the contact member 20 has been taken out from between the male terminal 12 and the female terminal 14, a protrusion amount X1 of the first contact portion 26a in the radial direction D2 and a protrusion amount X2 of the second contact portion 26b in the radial direction D2 are equal to each other. The protrusion amount X1 of the first contact portion 26a is the protrusion amount with respect to the upper end portion 22 and the intermediate portion 26m, and the protrusion amount X2 of the second contact portion 26b is the protrusion amount with respect to the lower end portion 24 and the intermediate portion 26m. In this configuration, the contact of the contact member 20 with the male terminal 12 and the female terminal 14 is stably maintained.

As described above, the terminal connection structure 10 in the embodiment is used in the dynamic power circuit of the electrified vehicle. In this case, a relatively large electric current flows through the terminal connection structure 10. When a large electric current flows through the male terminal 12 and the female terminal 14, the amount of heat generation becomes large in the contact member 20 that connects the two terminals 12, 14. For restraining the heat generation of the contact member 20, it is effective to increase the area of the contact of the contact member 20 with the male terminal 12 and the female terminal 14. However, in the case where the contact member 20 is enlarged in the axial direction D1 for increasing the contact area of the contact member 20, the range of the elastic deformation of the contact member 20 also increases when the male terminal 12 is inserted into the female terminal 14. As a result, an insertion load (that is, an insertion resistance) necessary for inserting the male terminal 12 into the female terminal 14 increases.

In this regard, with the terminal connection structure 10 in Embodiment 1, the increase in the insertion load can be restrained even when the contact member 20 is enlarged in the axial direction D1 and the contact area of the contact member 20 is increased. That is, when the male terminal 12 is inserted into the female terminal 14, the first contact portion 26a, first, elastically deforms, and thereafter, the second contact portion 26b elastically deforms. Thereby, a range of the contact member 20 where the elastic deformations concurrently occur is relatively small, so that the increase in the insertion load is restrained.

In the embodiment, each of the plurality of elastic pieces 26 includes the first contact portion 26a and the second contact portion 26b. In this configuration, the first contact portion 26a and the second contact portion 26b can be disposed evenly in the circumferential direction D3. Accordingly, the contact of the contact member 20 with the male terminal 12 and the female terminal 14 is stably maintained. All of the plurality of clastic pieces 26 do not need to include the first contact portion 26a and the second contact portion 26b, and at least one of the plurality of elastic pieces 26 only needs to include the first contact portion 26a and the second contact portion 26b. The number of contact portions 26a, 26b of the elastic pieces 26 that are provided along the axial direction D1 is not limited to two, and the elastic piece 26 may include three or more contact portions.

In addition, in the contact member 20 in the embodiment, the first contact portion 26a extends from the upper end portion 22 to the intermediate portion 26m of the clastic piece 26, and the second contact portion 26b extends from the lower end portion 24 to the intermediate portion 26m of the elastic piece 26. This configuration has an aspect in terms of the increase in the contact area of the contact member 20.

### Embodiment 2

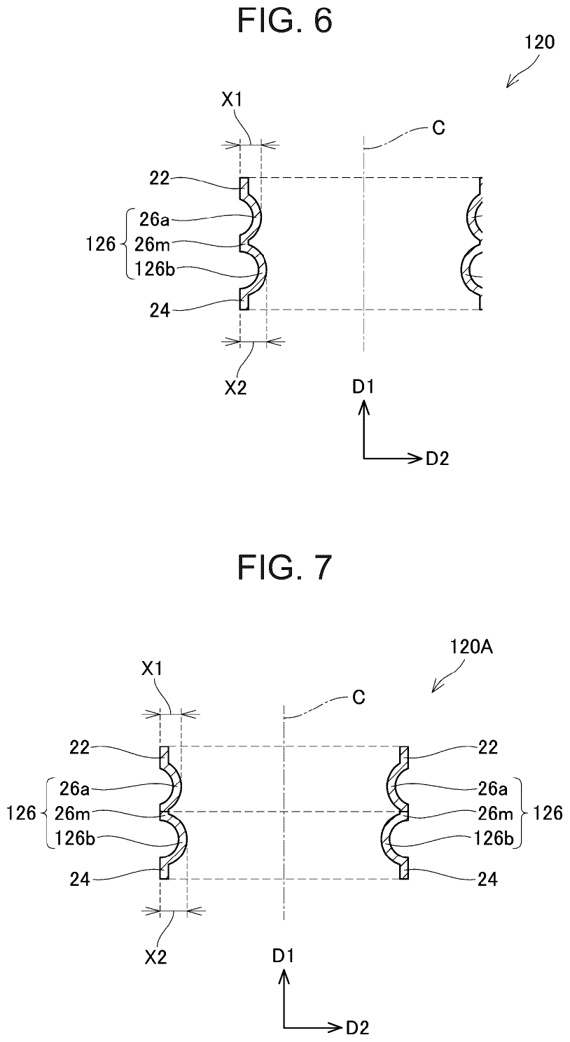

A terminal connection structure in Embodiment 2 will be described with reference to FIG. 6. As shown in FIG. 6, a contact member 120 in Embodiment 2 includes an upper end portion 22, a lower end portion 24, and a plurality of elastic pieces 126 that extends between the upper end portion 22 and the lower end portion 24. Each of the plurality of clastic pieces 126 includes a first contact portion 26a, a second contact portion 126b, and an intermediate portion 26m that is positioned between the first contact portion 26a and the second contact portion 126b. In each elastic piece 126, the elastic deformation amount of the first contact portion 26a in the radial direction D2 is smaller than the elastic deformation amount of the second contact portion 126b in the radial direction D2. That is, in the contact member 120 having a shape in a natural state where the contact member 120 has been taken out from between the male terminal 12 and the female terminal 14, the protrusion amount X1 of the first contact portion 26a in the radial direction D2 is smaller than the protrusion amount X2 of the second contact portion 126b in the radial direction D2. The protrusion amount X1 of the first contact portion 26a is the protrusion amount with respect to the upper end portion 22 and the intermediate portion 26m, and the protrusion amount X2 of the second contact portion 126b is the protrusion amount with respect to the lower end portion 24 and the intermediate portion 26m. In this way, the first contact portion 26a and the second contact portion 126b are configured to have different elastic deformation amounts from each other, and in this respect, the contact member 120 in Embodiment 2 is different from the contact member 20 in Embodiment 1.

The other configurations of the contact member 120 are the same as those in the terminal connection structure 10 in Embodiment 1. In addition, in the embodiment, particularly, the first contact portion 26a is provided at a position that is closer to an opening (an insertion opening into which the male terminal 12 is inserted) of the hole 14h of the female terminal 14 than the second contact portion 126b is. In this configuration, the elastic deformation amount of the first contact portion 26a positioned on the insertion opening side of the hole 14h of the female terminal 14 can be relatively lessened, and the insertion load can be more effectively reduced.

The contact member 120 in Embodiment 2 is integrally formed such that the first contact portion 26a and the second contact portion 126b constitute a single member. However, without being limited to this, the contact member 120 may be configured by a combination of a plurality of members. For example, in a modification shown in FIG. 7, the contact member 120A is configured by combining a single member including the first contact portion 26a and a single member including the second contact portion 126b. In this configuration, even when the shapes of the first contact portion 26a and the second contact portion 126b are different from each other, contact portions (first contact portions 26a or second contact portions 126b) having the same shape only needs to be provided on each member that constitutes the contact member 120A. Thereby, each member that constitutes the contact member 120A can be easily produced with high accuracy.

### Embodiment 3

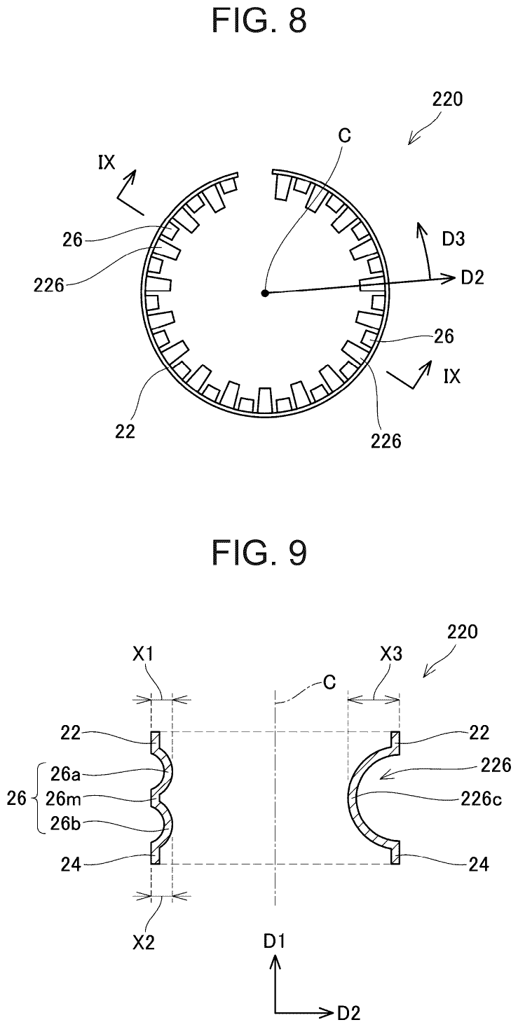

With reference to FIG. 8 and FIG. 9, a terminal connection structure in Embodiment 3 will be described. As shown in FIG. 8 and FIG. 9, a contact member 220 in Embodiment 3 includes a plurality of first elastic pieces 26 and a plurality of second elastic pieces 226. The plurality of first elastic pieces 26 and the plurality of second elastic pieces 226 extend between the upper end portion 22 and the lower end portion 24. The plurality of first elastic pieces 26 can be configured similarly to the plurality of elastic pieces 26 in Embodiment 1, such that each first elastic piece 26 includes both of the first contact portion 26a and second contact portion 26b that elastically deforms in the radial direction D2. Each of the plurality of second elastic pieces 226 includes a third contact portion 226c. The third contact portion 226c is larger in the dimension in the axial direction D1 than each of the first contact portion 26a and the second contact portion 26b. In this way, in the contact member 220, the plurality of second elastic pieces 226 each of which includes the third contact portion 226c is further provided, and in this respect, the contact member 220 in Embodiment 3 is different from the contact member 20 in Embodiment 1. The other configurations of the contact member 220 are the same as those in the terminal connection structure in Embodiment 1.

Further, in the contact member 220, the first elastic piece 26 and the second elastic piece 226 are alternately arranged along the circumferential direction D3. In this configuration, the plurality of first elastic pieces 26 each of which includes both of the first contact portion 26a and the second contact portion 26b and the plurality of second elastic pieces 226 each of which includes the third contact portion 226c can be disposed evenly in the circumferential direction D3. Accordingly, the contact of the contact member 220 with the male terminal 12 and the female terminal 14 is stably maintained. The array order of the first elastic pieces 26 and the second elastic pieces 226 in the circumferential direction D3 is not limited to this, and can be freely designed. For example, as another embodiment, in the contact member, two or more first elastic pieces 26 adjacent to each other and two or more second elastic pieces 226 adjacent to each other may be alternately arranged along the circumferential direction D3.

As for the first elastic piece 26, the first contact portion 26a extends from the upper end portion 22 to the intermediate portion 26m of the first elastic piece 26, and the second contact portion 26b extends from the lower end portion 24 to the intermediate portion 26m of the first elastic piece 26. As for the second elastic piece 226, the third contact portion 226c extends from the upper end portion 22 to the lower end portion 24. This configuration has an aspect in terms of the increase in the contact area of the contact member 220.

Although not particularly limited, the length of the first elastic piece 26 in the axial direction D1 and the length of the second elastic piece 226 in the axial direction D1 are equal to each other. As described above, the third contact portion 226c is larger in the dimension in the axial direction D1 than each of the first contact portion 26a and the second contact portion 26b. This configuration also has an aspect in terms of the increase in the contact area of the contact member 220.

In addition, the contact member 220 in the embodiment is formed from a single plate member, by press working or the like. Accordingly, the thickness of the first clastic piece 26 and the thickness of the second elastic piece 226 are equal to each other. That is, the first contact portion 26a, the second contact portion 26b, and the third contact portion 226c are equal in thickness to each other. In such a relation among the contact portions 26a, 26b, 226c, when the dimension of the third contact portion 226c in the axial direction D1 is relatively large, the clastic deformation amount of the third contact portion 226c in the radial direction D2 is larger than each of the elastic deformation amount of the first contact portion 26a in the radial direction D2 and the elastic deformation amount of the second contact portion 26b in the radial direction D2. That is, in the contact member 220 having a shape in a natural state where the contact member 220 has been taken out from between the male terminal 12 and the female terminal 14, a protrusion amount X3 of the third contact portion 226c in the radial direction D2 is larger than each of the protrusion amount X1 of the first contact portion 26a in the radial direction D2 and the protrusion amount X2 of the second contact portion 26b in the radial direction D2. Thereby, the third contact portion 226c can obtain a relatively high elastic property. The protrusion amount X1 of the first contact portion 26a is the protrusion amount of the first elastic piece 26 with respect to the upper end portion 22 and the intermediate portion 26m. The protrusion amount X2 of the second contact portion 26b is the protrusion amount of the first elastic piece 26 with respect to the lower end portion 24 and the intermediate portion 26m. The protrusion amount X3 of the third contact portion 226c is the protrusion amount of the second elastic piece 226 with respect to the upper end portion 22 and the lower end portion 24.

When the contact member 220 is disposed between the male terminal 12 and the female terminal 14 shown in FIG. 1, the contact member 220 contacts with the inner side surface 14a of the female terminal 14, at the upper end portion 22, the lower end portion 24, and the intermediate portion 26m. Moreover, the contact member 220 contacts with the outer side surface 12a of the male terminal 12, at the first contact portion 26a, the second contact portion 26b, and the third contact portion 226c. In this configuration, the contact member 220 is stably held between the male terminal 12 and the female terminal 14.

As described above, each terminal connection structure 10 disclosed in the present specification may be applied to only some of the plurality of terminal pairs 12, 14. With the terminal connection structure 10 according to the present technology, the gap between the male terminal 12 and the female terminal 14 can be relatively lessened. Accordingly, even when the terminal connection structure 10 according to the present technology is applied to only at least one of the plurality of terminal pairs 12, 14, the positioning of the whole of the plurality of male terminals 12 can be performed with respect to the whole of the plurality of female terminals 14, with high accuracy. In addition, the vibration of the male terminal 12 with respect to the female terminal 14 is restrained, in all of the plurality of terminal pairs 12, 14.

The male terminal 12 is a cylindrical member in the embodiments, but is not limited to this. For example, the male terminal 12 may be a polygonal column-shaped member. The hole of the female terminal 14 is not limited to the configuration in the embodiments, and the female terminal 14 does not need to demarcate the hole 14h having a cylindrical section. The shape of the hole of the female terminal 14 can be appropriately altered in accordance with the shape of the male terminal 12.

What is claimed is:

1. A terminal connection structure comprising:
a column-shaped male terminal that extends in an axial direction;
a female terminal that demarcates a hole into which the male terminal is inserted; and
at least one contact member that is sandwiched between an outer side surface of the male terminal and an inner side surface of the female terminal and that electrically connects the male terminal and the female terminal, wherein
the contact member includes a first contact portion and a second contact portion that are elastically deformed in a radial direction perpendicular to the axial direction, and
the first contact portion and the second contact portion are provided at different positions from each other in the axial direction.

2. The terminal connection structure according to claim 1, wherein:
the contact member includes a plurality of elastic pieces, and each of the plurality of elastic pieces extends in the axial direction and is arranged in a circumferential direction; and
at least one of the plurality of elastic pieces is a first elastic piece that includes the first contact portion and the second contact portion.

3. The terminal connection structure according to claim 2, wherein each of the plurality of elastic pieces is the first elastic piece that includes the first contact portion and the second contact portion.

4. The terminal connection structure according to claim 3, wherein:
the contact member includes an upper end portion and a lower end portion, the upper end portion extending in the circumferential direction, the lower end portion extending in the circumferential direction; and
the plurality of elastic pieces extends between the upper end portion and the lower end portion.

5. The terminal connection structure according to claim 4, wherein:
the first contact portion extends from the upper end portion to an intermediate portion of the first elastic piece; and
the second contact portion extends from the lower end portion to the intermediate portion of the first elastic piece.

6. The terminal connection structure according to claim 5, wherein the contact member contacts with the inner side surface of the female terminal, at the upper end portion, the lower end portion, and the intermediate portion, and contacts with the outer side surface of the male terminal, at the first contact portion and the second contact portion.

7. The terminal connection structure according to claim 5, wherein the contact member contacts with the outer side surface of the male terminal, at the upper end portion, the lower end portion, and the intermediate portion, and contacts with the inner side surface of the female terminal, at the first contact portion and the second contact portion.

8. The terminal connection structure according to claim 5, wherein an elastic deformation amount of the first contact portion in the radial direction is equal to an elastic deformation amount of the second contact portion in the radial direction.

9. The terminal connection structure according to claim 5, wherein an elastic deformation amount of the first contact portion in the radial direction is smaller than an elastic deformation amount of the second contact portion in the radial direction.

10. The terminal connection structure according to claim 9, wherein the first contact portion is provided at a position closer to an opening of the hole of the female terminal than the second contact portion.

11. The terminal connection structure according to claim 2, wherein:
at least one of the plurality of elastic pieces other than the first elastic piece is a second elastic piece including a third contact portion that is elastically deformed in the radial direction; and
a length of the third contact portion in the axial direction is longer than each length of the first contact portion and the second contact portion in the axial direction.

12. The terminal connection structure according to claim 11, wherein each of the plurality of elastic pieces is one of the first elastic piece and the second elastic piece.

13. The terminal connection structure according to claim 12, wherein the first elastic piece and the second elastic piece are alternately arranged on the contact member along the circumferential direction.

14. The terminal connection structure according to claim 11, wherein:
the contact member includes an upper end portion and a lower end portion, the upper end portion extending in the circumferential direction, the lower end portion extending in the circumferential direction; and
the plurality of elastic pieces extends between the upper end portion and the lower end portion.

15. The terminal connection structure according to claim 14, wherein:
the first contact portion extends from the upper end portion to an intermediate portion of the first elastic piece;
the second contact portion extends from the lower end portion to the intermediate portion of the first elastic piece; and
the third contact portion extends from the upper end portion to the lower end portion.

16. The terminal connection structure according to claim 15, wherein the contact member contacts with the inner side surface of the female terminal, at the upper end portion, the lower end portion, and the intermediate portion, and contacts with the outer side surface of the male terminal, at the first contact portion, the second contact portion, and the third contact portion.

17. The terminal connection structure according to claim 15, wherein the contact member contacts with the outer side surface of the male terminal, at the upper end portion, the lower end portion, and the intermediate portion, and contacts with the inner side surface of the female terminal, at the first contact portion, the second contact portion, and the third contact portion.

18. The terminal connection structure according to claim 1, wherein:
the terminal connection structure is equipped in an electrified vehicle;
one of the male terminal and the female terminal is electrically connected to an electric motor that drives a wheel of the electrified vehicle; and
the other of the male terminal and the female terminal is electrically connected to an electric power control circuit that controls an electric current that flows through the electric motor.
